(19) United States
(12) Patent Application Publication
(10) Pub. No.: US 2007/0274507 A1
(43) Pub. Date: Nov. 29, 2007

(54) AUTO ATTENDANT TELEPHONE SYSTEM

(76) Inventor: Matthew Sawyer, Irvine, CA (US)

Correspondence Address: ERICSSON INC., 6300 LEGACY DRIVE, M/S EVR 1-C-11, PLANO, TX, 75024, US

(21) Appl. No.: 11/382,561

(22) Filed: May 10, 2006

(51) Int. Cl. H04M 3/00; H04M 5/00

(52) U.S. Cl. 379/265.02

(57) ABSTRACT

An auto attendant system in which a plurality of individually scheduled auto attendants can either receive calls on direct lines from outside a company or on links from other auto attendants in the company, without having to store redundant menu choices in more than one location. When a caller selects a menu choice in a first auto attendant requesting to be transferred to a second auto attendant, the call is transferred directly to the scheduler for the second auto attendant, thus eliminating the need for complex routing tables. The scheduler in the second auto attendant presents the caller with a menu as determined by the second auto attendant's schedule.

### CROSS-REFERENCE TO RELATED APPLICATIONS

NOT APPLICABLE

### STATEMENT REGARDING FEDERALLY SPONSORED RESEARCH OR DEVELOPMENT

NOT APPLICABLE

### REFERENCE TO SEQUENCE LISTING, A TABLE, OR A COMPUTER PROGRAM LISTING COMPACT DISC APPENDIX

NOT APPLICABLE

### BACKGROUND OF THE INVENTION

The present invention relates to telephony systems. More particularly, and not by way of limitation, the present invention is directed to an auto attendant telephone system having multiple auto attendants with independent schedules.

Auto attendants, otherwise known as automated telephone answering systems, have been known for many years. Their primary purpose is to automatically direct calls received by a company to the most appropriate location within the company. The auto attendant prompts callers to make numerical or voice selections corresponding to the department or person to which they want to be connected. This reduces the number of human operators or receptionists that are needed, providing a substantial cost savings for the company.

Typically, auto attendants today are either hosted by a voice mail system or are implemented as an Interactive Voice Response (IVR) system. Voice mail hosted systems are typically mailbox oriented. Functionality is provided through the use of various types of mailboxes that serve different purposes. IVR systems are typically script oriented. The call flow is scripted into the IVR application. The present invention relates to voice mail hosted auto attendants.

A problem with existing voice mail hosted auto attendants is that customers perceive them to be difficult to learn, setup, and maintain, which makes their total cost of ownership more expensive than the customer believes they should be. While it is usually fairly easy to set up a menu mailbox that presents a list of menu options to the caller, the current implementations get much more complex when there is a need for several multi-level auto attendants that need to function on their own individual schedules.

Oftentimes, companies have the need for several auto attendants providing different functionality to callers. In addition to a central company auto attendant, a company may want to have several externally accessible departmental auto attendants to handle sales calls, customer service calls, technical support calls, and the like. In addition, the company may want several internal-only auto attendants to handle employee calls coming into departments such as Human Resources (HR) or Information Technology (IT). While the company's main hours of operation may be 8:00 am to 5:00 pm on weekdays, it is quite common for various departments of the company to operate on different schedules. For example, the IT department may work 7:00 am to 6:00 pm on weekdays so that employees who arrive a bit earlier or leave a bit later still have IT support.

Auto attendants in most voice mail systems are very inefficient at handling individual schedules for several auto attendants. In general, non-mailbox based schedulers are adequate when the only access to the auto attendant comes from an external call directly into the auto attendant. The scheduler is typically configured by the system administrator in a table as part of the system configuration. The table contains a dialed number, a date/time range, and the menu mailbox to use.

This methodology works fine if the only access to the auto attendant is an external call directly to the auto attendant where the scheduler is located. For example, the Technical Support department may have a direct line that customers can call for assistance. Typically, however, the departmental scheduler is no longer usable if the system internally transfers control to the departmental auto attendant from another interconnected auto attendant in the company. For example, if a customer calls the central company auto attendant and wants to transfer to Technical Support, the central company auto attendant scheduler determines the routing of the call. If the central company auto attendant scheduler is in night mode, the customer may not be able to reach a desired location in the company even though that department is still working.

In order to retain scheduling capabilities in departmental auto attendants, the central company auto attendant may transfer the call completely out of the system and back into the correct auto attendant as an external call instead of internally transferring control directly from one auto attendant to another. This makes the system inefficient as it ties up voice mail ports while externally transferring calls between different auto attendants.

Another possible solution is to load the schedules directly into the secondary auto attendant menu mailbox. However, this complexity leads to its own set of problems. First, the caller has to be prompted with multiple menu choices, and if the menu choices are not fixed, then the system must somehow dynamically generate the prompts. In some systems, scheduling for departmental or secondary auto attendants is performed through the use of a spreadsheet and a call processor. The schedules and mailbox numbers for each secondary auto attendant are entered into a spreadsheet and then the schedule in the spreadsheet is invoked by linking the spreadsheet into an end-user mailbox that allows specialized scripting functionality. Calls to the auto attendant are directed to a menu mailbox that, in turn, automatically transfers control to the end-user mailbox containing the scripting to link in the schedule spreadsheet for evaluating the schedule.

This method has its own set of problems. For example, it utilizes additional overhead in terms of additional mailboxes needed since it requires an end-user mailbox to host the schedule spreadsheet for each auto attendant. Additionally, the spreadsheet itself is typically created and modified using third-party software. Furthermore, this methodology does not solve the problem of complexity in configuring the system.

Thus, existing auto attendant systems are complex and inefficient when a company desires to have multiple individually scheduled auto attendants. The current art needs an improved system and method for handling incoming calls and internally transferring calls between individually scheduled auto attendants. The present invention provides such a system and method.

### BRIEF SUMMARY OF THE INVENTION

The present invention provides an auto attendant system in which a plurality of individually scheduled auto attendants can either receive calls on direct lines from outside the company or on links from other auto attendants in the company, without having to store redundant menu choices in more than one location. When a caller selects a menu choice in a first auto attendant requesting to be transferred to a location serviced by a second auto attendant, the call is transferred directly to the scheduler for the second auto attendant. The scheduler presents the caller with a day menu or night menu as determined by the second auto attendant's schedule.

The invention provides an auto attendant system having reduced complexity, resulting in a shorter learning curve for the system administrator and less time to set up and maintain the system. The invention also provides increased flexibility, resulting in more uses without the need to move to a more expensive and complex IVR system. No redundant mailboxes are necessary thus requiring less time to setup and maintain the auto attendant. Additionally, there is no need to transfer calls out of the system and back into the system to transfer control from one auto attendant to another. This eliminates the inefficient use of voice mail ports found in prior art systems.

The invention further eliminates the potential for duplication errors if the administrator makes a change to one duplicated mailbox and forgets to make the same change to the other copies. Additionally, routing to the desired auto attendant scheduler can be performed automatically using the same methods currently utilized for transfers to end-user mailboxes. This makes complex call routing tables unnecessary. Finally, a new auto attendant mailbox type is utilized together with modified pre-existing functionality to make implementation fairly simple.

Thus, in one aspect, the present invention is directed to an auto attendant telephone system for automatically answering and routing an incoming telephone call. The system includes a plurality of auto attendants, each of which includes means for receiving the incoming call directly from a caller when the caller dials a direct number associated with the auto attendant, and means for receiving the call routed from another of the plurality of auto attendants when the caller dials a direct number associated with the other auto attendant. Each auto attendant also includes a plurality of selection menus for selecting by the caller, a desired destination for routing the call; and a scheduler for determining which of the selection menus to present to the caller. Each auto attendant scheduler is independent of the schedulers of others of the plurality of auto attendants. The selected destination may comprise either a final destination for the call or another of the plurality of auto attendants. The system also includes means for routing the call from a first auto attendant to the scheduler of a second auto attendant of the plurality of auto attendants in accordance with the selected desired destination. The scheduler of the second auto attendant then presents a selection menu to the caller in accordance with the schedule of the second auto attendant independent of the scheduler of the first auto attendant.

In another aspect, the present invention is directed to a method of automatically answering and routing an incoming telephone call in an auto attendant telephone system having a plurality of auto attendants, wherein each auto attendant can receive an incoming call directly from a caller when the caller dials a direct number associated with the auto attendant, or can receive the call from another of the plurality of auto attendants when the caller dials a direct number associated with the other auto attendant. The method includes the steps of receiving a call in a first auto attendant; and selecting by a scheduler in the first auto attendant, a selection menu of destinations to present to the caller, wherein each auto attendant includes a scheduler that is independent of the schedulers of others of the plurality of auto attendants. It is then determined whether the caller selected from the menu, a second auto attendant of the plurality of auto attendants as a desired destination. If so, the method includes routing the call from the first auto attendant to the second auto attendant in accordance with the selected desired destination. The routing step includes routing the call from the first auto attendant to a scheduler of the second auto attendant. The scheduler in the second auto attendant then presents a selection menu to the caller in accordance with a schedule for the second auto attendant, wherein the second auto attendant scheduler presents the selection menu independently of the scheduler of the first auto attendant.

In yet another aspect, the present invention is directed to an auto attendant telephone system for automatically answering and routing an incoming telephone call. The system includes a plurality of auto attendants, wherein each auto attendant includes a direct line for receiving an incoming call directly from a caller, and an internal connection for receiving the call from another of the plurality of auto attendants. Each of the plurality of auto attendants includes a plurality of selection menus enabling a caller to select a desired destination for routing the call, and a scheduler for determining which of the selection menus to present to the caller. Each auto attendant scheduler is independent of the schedulers of others of the plurality of auto attendants. The system also includes means for routing the call from a first auto attendant to a second auto attendant of the plurality of auto attendants in accordance with the selected desired destination, wherein the routing means routes the call from the first auto attendant to the scheduler of the second auto attendant. The second auto attendant then presents a selection menu to the caller in accordance with the scheduler of the second auto attendant independent of the scheduler of the first auto attendant.

### BRIEF DESCRIPTION OF THE SEVERAL VIEWS OF THE DRAWINGS

In the following section, the invention will be described with reference to exemplary embodiments illustrated in the figures, in which:

FIG. 1 is a block diagram illustrating an auto attendant system and method of interconnecting a plurality of auto attendants in the system in accordance with the teachings of the present invention.

### DETAILED DESCRIPTION OF THE INVENTION

The present invention is described herein in the context of an exemplary embodiment in which a plurality of interconnected auto attendants are implemented in a company having a main company auto attendant and several departmental auto attendants, each of which operates on its own schedule. It should be understood that the invention is applicable to auto attendant systems in any kind of business, and no auto attendant is necessarily in control of any other auto attendant in the system. The terms “main” and “departmental” are not meant to be limiting, but are merely applicable to one exemplary embodiment. In other embodiments such as an auto attendant in a bank, a first auto attendant may direct the caller to other auto attendants that control functions such as requesting account balances, requesting new checks or deposit envelopes, transferring funds between accounts, and the like.

For simplicity, each auto attendant is shown herein to have a day menu and a night menu, although in practice, the auto attendants may have additional menus to cover, for example, additional working periods, weekends, and holidays, each of which may be unique for each auto attendant.

The present invention introduces a new type of mailbox, referred to herein as an Auto Attendant mailbox. The Auto Attendant mailbox is the starting point for an auto attendant and will contain the schedule for the auto attendant. For example:

Auto Attendant 1000 - Main Company Auto Attendant

| Time | Date | Mailbox | Description |
|---|---|---|---|
| 8:00 am | M-F | 1001 | Main Menu - Day |
| 5:00 pm | M-F | 1002 | Main Menu - Night |

The auto attendant mailbox re-directs calls to the appropriate mailbox containing the menu options. In the above example, mailbox 1001 contains the menu options during working hours (Day), and mailbox 1002 contains the menu options during non-working hours (Night).

There are a few different methods of routing calls to the Auto Attendant mailbox when a call comes into the system. The first method is to use a call routing table. The call routing table maps a dialed number to an auto attendant mailbox. For example:

Call Routing

| Number | Mailbox | Description |
|---|---|---|
| 1000 | 1000 | Main Company Auto Attendant |
| 2000 | 2000 | Sales Department |
| 3000 | 3000 | Technical Support Department |

This method, however, does not allow for encapsulation of the entire auto attendant configuration in a single location. A preferable method is to add a field to the Auto Attendant mailbox for the dialed number(s) that the Auto Attendant mailbox would be linked to. For example:

Auto Attendant 1000 - Main Company
Auto Attendant Dialed Number: 1000

| Time | Date | Mailbox | Description |
|---|---|---|---|
| 8:00 am | M-F | 1001 | Main Menu - Day |
| 5:00 pm | M-F | 1002 | Main Menu - Night |

This allows encapsulation of all of the settings for the auto attendant in one location. If the system supports automatic mapping of the dialed number to the mailbox with the same number, then neither a call routing table nor a setting for the dialed number is necessary. However, without one method or the other, the system is not capable of mapping calls to an auto attendant mailbox that does not have the same number as the dialed number, thus reducing the flexibility of the system.

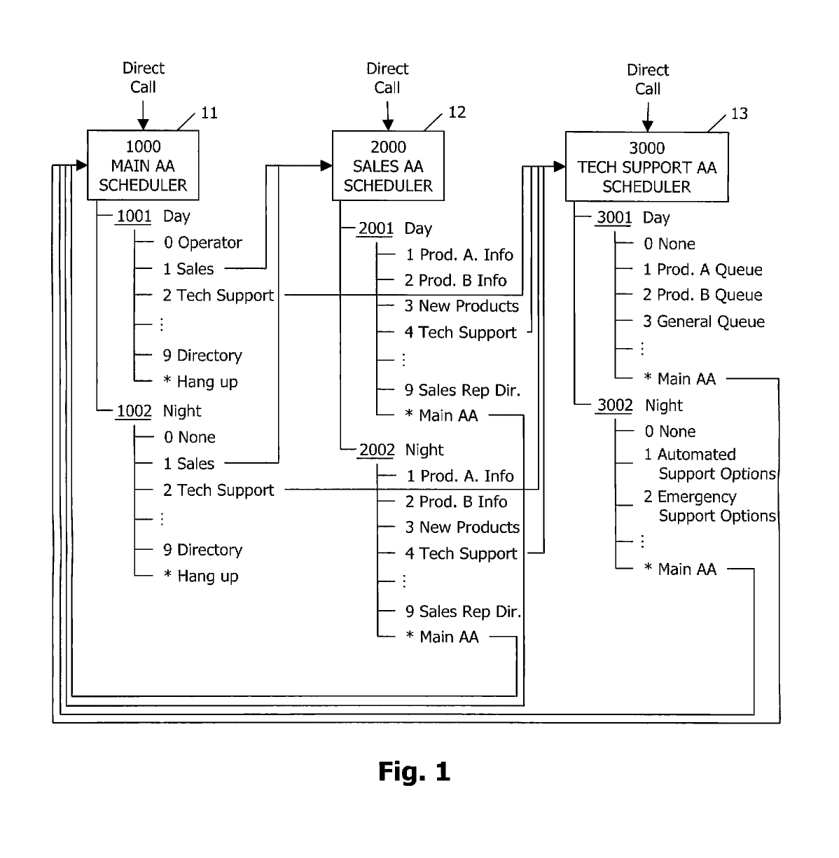

FIG. 1 is a block diagram illustrating an exemplary embodiment of an auto attendant system having multiple individually scheduled auto attendants linked according to the present invention. A main company auto attendant 11, a sales department auto attendant 12, and a technical support department auto attendant 13 are included in the system. Each auto attendant receives direct calls on its own direct line. For example, the main company auto attendant is reached by dialing 1000; the sales department auto attendant is reached by dialing 2000; and the technical support department auto attendant is reached by dialing 3000. Directly dialing a departmental auto attendant puts the caller directly into the departmental scheduler.

Each auto attendant is created by first creating an Auto Attendant mailbox and then creating two single-digit menus, one for day and one for night. For example, the Auto Attendant mailbox for the Technical Support department may be created as follows:

Auto Attendant 3000 - Tech Support Auto Attendant

| Time | Date | Mailbox | Description |
|---|---|---|---|
| 7:00 am | M-F | 3001 | Tech Support Menu - Day |
| 6:00 pm | M-F | 3002 | Tech Support Menu - Night |

The day menu and night menu for the Technical Support department may be created as follows:

Menu 3001 - Tech Support Menu - Day

| Key | Action | Key | Action |
|---|---|---|---|
| 0 | None | 6 | None |
| 1 | Product A queue | 7 | None |
| 2 | Product B queue | 8 | None |
| 3 | General queue | 9 | None |
| 4 | None | * | Go to Main AA |
| 5 | None | # | None |

Menu 3002 - Tech Support Menu - Night

| Key | Action | Key | Action |
|---|---|---|---|
| 0 | None | 6 | None |
| 1 | Play msg - Support Info | 7 | None |
| 2 | Emergency Menu | 8 | None |
| 3 | None | 9 | None |
| 4 | None | * | Go to Main AA |
| 5 | None | # | None |

Thus, during the day, a caller who calls the Technical Support direct line may hear the following menu options:

Thank you for calling XYZ Corporation's Technical Support line.

For technical support for Product A, press 1
For technical support for Product B, press 2
For all other products, press 3
For the company main menu, press ‘star’.

At night or during time periods the company is closed, the menu might be:

Thank you for calling XYZ Corporation's Technical Support line. The Technical Support center is now closed. Our office hours are 7 am until 6 pm Monday through Friday.

For information about 24-hr automated support options, press 1
To request emergency support, press 2
For the company main menu, press ‘star’.

Selecting * on either of these menus transfers the caller to the Main Company auto attendant 11, which uses its own scheduler to determine which menu to present to the caller. For example, if the call came in on the Technical Support direct line at 7:30 am, the Technical Support department auto attendant scheduler 13 would utilize the day menu (3001) to provide options to the caller because the Technical Support day starts at 7:00 am. However, if the caller transfers to the Main Company auto attendant, the Main Company auto attendant scheduler would utilize the night menu (1002) to provide options to the caller because the Main Company day does not start until 8:00 am.

Likewise, from the Main Company menu, the caller may request to be transferred to either the Sales department or the Technical Support department. The auto attendant system transfers the caller to the scheduler for the requested department, which then selects the appropriate menu in accordance with its own schedule.

Likewise, a caller to the Sales department may select ‘4’ to be transferred to the Technical Support department, or may select * to be transferred to the Main Company menu. The auto attendant system transfers the caller to the scheduler for the requested auto attendant, which then selects the appropriate menu in accordance with its own schedule.

The ability to link auto attendants together in this manner eliminates redundancy when the same auto attendant functionality is needed in various locations. For example, changes to the Technical Support auto attendant only need to be made in one location. In prior art systems in which the Technical Support auto attendant received calls both directly and through internal transfers, the menu information had to be stored both in the Technical Support auto attendant and in the auto attendants that forwarded calls to the Technical Support auto attendant. In the present invention, all other auto attendants that link to the Technical Support auto attendant do not need additional changes.

As will be recognized by those skilled in the art, the innovative concepts described in the present application can be modified and varied over a wide range of applications. Accordingly, the scope of patented subject matter should not be limited to any of the specific exemplary teachings discussed above, but is instead defined by the following claims.

What is claimed is:

1. An auto attendant telephone system for automatically answering and routing an incoming telephone call, said system comprising:
a plurality of auto attendants, each of the auto attendants including:
means for receiving the incoming call directly from a caller when the caller dials a direct number associated with the auto attendant;
means for receiving the call routed from another of the plurality of auto attendants when the caller dials a direct number associated with the other auto attendant;
a plurality of selection menus for selecting by the caller, a desired destination for routing the call; and
a scheduler for determining which of the selection menus to present to the caller, wherein each auto attendant scheduler is independent of the schedulers of others of the plurality of auto attendants; and
means for routing the call from a first auto attendant to a second auto attendant of the plurality of auto attendants in accordance with the selected desired destination, said routing means routing the call from the first auto attendant to the scheduler of the second auto attendant;
wherein the second auto attendant presents a selection menu to the caller in accordance with the scheduler of the second auto attendant independent of the scheduler of the first auto attendant.

2. The auto attendant telephone system according to claim 1, wherein the plurality of auto attendants are associated with a plurality of departments in a company.

3. The auto attendant telephone system according to claim 2, wherein the plurality of auto attendants includes a main company auto attendant and at least one departmental auto attendant.

4. The auto attendant telephone system according to claim 1, wherein each auto attendant's scheduler determines which of the selection menus to present to the caller based on the time of day and an associated work schedule.

5. The auto attendant telephone system according to claim 4, wherein each auto attendant's scheduler also determines which of the selection menus to present to the caller based on the day of the week and the associated work schedule.

6. A method of automatically answering and routing an incoming telephone call in an auto attendant telephone system having a plurality of auto attendants, wherein each auto attendant can receive an incoming call directly from a caller when the caller dials a direct number associated with the auto attendant, or can receive the call from another of the plurality of auto attendants when the caller dials a direct number associated with the other auto attendant, said method comprising:
receiving a call in a first auto attendant;
selecting by a scheduler in the first auto attendant, a selection menu of destinations to present to the caller, wherein each auto attendant includes a scheduler that is independent of the schedulers of others of the plurality of auto attendants;
determining whether the caller selected from the menu, a second auto attendant of the plurality of auto attendants as a desired destination;
upon determining that the caller selected the second auto attendant, routing the call from the first auto attendant to the second auto attendant in accordance with the selected desired destination, said routing step including routing the call from the first auto attendant to a scheduler of the second auto attendant; and
presenting by the scheduler in the second auto attendant, a selection menu to the caller in accordance with a schedule for the second auto attendant, said second auto attendant scheduler presenting the selection menu independently of the scheduler of the first auto attendant.

7. The method according to claim 6, wherein the auto attendant telephone system is implemented in a company having a plurality of departments, each of which has an associated departmental auto attendant, wherein:
the step of receiving a call in a first auto attendant includes receiving a call in a main company auto attendant;
the step of determining whether the caller selected a second auto attendant includes determining whether the caller selected a given department in the company as a destination for the call; and
the step of routing the call from the first auto attendant to the second auto attendant includes routing the call to the scheduler of the given department's auto attendant.

8. The method according to claim 7, wherein each auto attendant's scheduler determines which of the selection menus to present to the caller based on the time of day and the work schedule for the associated department.

9. The method according to claim 8, wherein each auto attendant's scheduler also determines which of the selection menus to present to the caller based on the day of the week and the work schedule for the associated department.

10. The method according to claim 6, wherein the auto attendant telephone system is implemented in a bank providing its customers with a plurality of automated functions accessible by telephone, each of said functions having an associated auto attendant, wherein:
the step of receiving a call in a first auto attendant includes receiving a call in the bank's central auto attendant;
the step of determining whether the caller selected a second auto attendant includes determining whether the caller selected a given automated function as a destination for the call; and
the step of routing the call from the first auto attendant to the second auto attendant includes routing the call to the scheduler of the given automated function's auto attendant.

11. An auto attendant telephone system for automatically answering and routing an incoming telephone call, said system having a plurality of auto attendants, wherein each auto attendant includes a direct line for receiving an incoming call directly from a caller, and an internal connection for receiving the call from another of the plurality of auto attendants, said system comprising:
within each of the plurality of auto attendants:
a plurality of selection menus for selecting by the caller, a desired destination for routing the call; and
a scheduler for determining which of the selection menus to present to the caller, wherein each auto attendant scheduler is independent of the schedulers of others of the plurality of auto attendants; and
means for routing the call from a first auto attendant to a second auto attendant of the plurality of auto attendants in accordance with the selected desired destination, said routing means routing the call from the first auto attendant to the scheduler of the second auto attendant;
wherein the second auto attendant presents a selection menu to the caller in accordance with the scheduler of the second auto attendant independent of the scheduler of the first auto attendant.

12. The auto attendant telephone system according to claim 11, wherein the plurality of auto attendants are associated with a plurality of departments in a company.

13. The auto attendant telephone system according to claim 12, wherein the plurality of auto attendants includes a main company auto attendant and at least one departmental auto attendant.

14. The auto attendant telephone system according to claim 12, wherein each auto attendant's scheduler determines which of the selection menus to present to the caller based on the time of day and the work schedule for the associated department.

15. The auto attendant telephone system according to claim 14, wherein each auto attendant's scheduler also determines which of the selection menus to present to the caller based on the day of the week and the work schedule for the associated department.

16. The auto attendant telephone system according to claim 11, wherein the plurality of auto attendants are associated with a plurality of automated functions in a bank.
